(19) United States
(12) Patent Application Publication
(10) Pub. No.: US 2026/0227282 A1
(43) Pub. Date: Aug. 6, 2026

(54) COMPUTER PROGRAM IMPLEMENTED METHOD FOR AUTOMATED VERIFICATION OF THE SEQUENCING LOGIC OF THE OPENING OF BLOWDOWN VALVES AND READABLE NON-TRANSIENT STORAGE MEDIUM

(71) Applicants: PETRÓLEO BRASILEIRO S.A. - PETROBRAS, RIO DE JANEIRO (BR); VERTESIS SOFTWARE LTDA, Florianópolis (BR)

(72) Inventors: Marcelo Lopes De LIMA, Rio de Janeiro (BR); Luiz Carlos De Azevedo FONSECA, Rio de Janeiro (BR); Rodrigo Tacla SAAD, Florianópolis (BR)

(73) Assignees: PETRÓLEO BRASILEIRO S.A. - PETROBRAS, RIO DE JANEIRO (BR); VERTESIS SOFTWARE LTDA, Florianópolis (BR)

(21) Appl. No.: 19/456,306

(22) Filed: Jan. 22, 2026

(30) Foreign Application Priority Data
Jan. 30, 2025 (BR) 1020250018675

(51) Int. Cl. G01M 13/003; G05B 19/048

(52) U.S. Cl. CPC G01M 13/003; G05B 19/048; G05B 2219/25297

(57) ABSTRACT

Computer program implemented method for automated verification of sequencing logic of opening of blowdown valves (BDVs) is aided by purpose-developed software components allowing much larger number of test cases (or scenarios) compared to the prior approach. The method is based on a scenario-guided prioritization study, wherein, given a set of scenarios to be tested, decay curves of the blowdown valves, and prioritization rules, the computer program implemented method is used in a chained manner, which comprises the main steps of: standardization of scenario definition; calculation of sequencing of blowdown valves that respects the capacity limit of safety equipment (Flare) and prioritization rules for each scenario; generation of configuration files for r the sequencing tests and the possibility of visualization allowing analysis by a specialist; automated testing of each scenario; and generation of a report with the tests result, indicating whether or not the implemented logic met the expected sequencing.

### RELATED APPLICATION DATA

This application is based on and claims priority to Brazilian Application No. BR 10 2025 001867 5, filed on Jan. 30, 2025, the entire contents of which are incorporated herein by reference.

### TECHNICAL FIELD

The present invention pertains to the oil and gas industry, more specifically is related to the automated verification of sequencings that can be described by priorities and rules for composing these priorities. It has particular application in the sequencing of BDVs (“Blowdown Valves”—depressurization valves or discharge valves) openings in offshore production units and refers to an automated testing or verification method. The method is implemented by a computer program, which automates the tests, with the practical advantage of allowing a much larger number of test cases or scenarios and with better traceability compared to the approach prior to the invention.

### BACKGROUND OF THE INVENTION

Blowdown valves (BDVs) or discharge valves are valves that remain closed during the normal operation of production units, such as oil platforms, and are opened in emergency scenarios, such as in cases of fire in the production area. Their purpose is to relieve the gas inventory for the flare, thus avoiding potentially serious consequences.

The flare is a safety device that burns gas in a controlled manner, preventing its direct release into the atmosphere. The flow rate of gas relieved by the flare must be controlled so as not to exceed its operational limit.

Due to the large gas inventories accumulated in production units, such as FPSO-type offshore platforms, the simultaneous opening of BDVs could exceed the flare's capacity. In many cases, therefore, it is necessary to sequence the opening of the BDV valves in emergency scenarios to ensure that the flare's capacity is not exceeded.

The proper sequencing of opening of these valves depends on the emergency scenario, the characteristics of the involved BDVs, the flow rate of each BDV valve, and the flare's capacity. This sequencing needs to adapt in real time, considering the actions of the operator, who can manually open any BDV at any time, as well as the possibility of occurrence of concurrent scenarios.

The logic that implements the automatic sequencing of the BDVs in the various possible scenarios is, therefore, complex, dynamic (it cannot be established with fixed times) and needs to be correct to avoid severe damage to the facilities, people, or the environment, as would be the case if the flare's capacity were exceeded.

Verifying the operation of the implemented logic through testing assumes a combinatorial nature, due to the numerous possibilities of concurrent scenarios and manual interventions by operators. Furthermore, it is not possible to accurately predict when these interventions may occur.

The technical problem, therefore, is related to verifying the functioning of the logic implemented in the systems that control the sequencing of the BDVs, in order to guarantee its correctness for a large number of possible scenarios. The approach prior to the invention consists of manual testing of scenarios, in which the people responsible for verifying the correct functioning of the logic manually simulate the characteristic conditions of each possible scenario, the operator's intervention at agreed times, and the occurrence of concurrent scenarios.

The behavior of the logic is recorded and then compared with the expected behavior, calculated by using spreadsheets that take into account the application of prioritization rules and the characteristics of the BDVs. It is necessary to calculate the sequencing for each combination, record the actions and times, and produce detailed reports. This supervised testing process is costly, as it must test all predefined scenarios, extends over several days, and requires careful observation.

In order to overcome these limitations described above, the present invention establishes a test method for automated verification of the sequencing logic of the opening of Blowdown Valves (BDVs) or discharge valves. The method is implemented by a computer program, with the practical advantage of allowing unsupervised testing of a large number of cases (or scenarios), much larger than would be possible manually, in much less time (hours instead of weeks), at a lower cost.

### STATE OF THE ART

Document U.S. Pat. No. 7,869,889B2 describes a distributed and adaptable intelligent logic with multiple communication devices for reliable shutdown of the safety system to monitor and control field devices in chemical and other industrial processes. The final elements of the system and method include emergency isolation valves, flow rate control valves, valve actuators, pump controllers, and motor starters.

The proposal in this document defines a logic that is adaptable to dynamic conditions and avoids unnecessary shutdowns. The present invention, however, does not define the logic for driving the BDVs, nor the infrastructure necessary for the execution of the logic. The logic is a consequence of the flare flow rate limit, the flow rate characteristic of the BDVs, the priorities, and the rules for changing these priorities.

More specifically, the present invention proposes a method for testing the logic implemented in the logic executor. That is, there is desired a method that ensures that the implemented logic behaves as expected. If applied to the aforementioned document, the invention would aim to verify whether what was proposed in said document had been implemented correctly and would be operating correctly, as expected. In short, the present invention addresses to testing the implemented logic to ensure that the implementation was correct, and not to the logic itself.

In turn, document U.S. Pat. No. 8,720,267B2 addresses to a system for online testing of an emergency shut-off valve to improve the Safety Integrity Level (SIL) rating and analyzes certain scenarios using partial stroke tests of an emergency shut-off valve coupled to a supplemental fuel control valve.

Note that this document deals with a partial valve testing to ensure that, when required, the valve performs the function for which it was designed. Unlike the present invention, the document does not refer to the logic tests that would eventually require the actuation of this valve. It is irrelevant to the present invention how the BDVs are tested to ensure that they actuate when required. The present invention focuses on logic testing and not on the valves themselves.

Finally, document U.S. Pat. No. 9,523,971B2 describes method for monitoring and controlling valves in industrial process control and automation (including in the oil and gas industry) to acquire valve parameters through a port and send the parameters to any portable device via NFC for analysis. Unlike the present invention, it is noted that this document focuses on testing the functionality of system components and not on testing the logic of valve opening sequencing, as the present invention does.

More clearly, the present invention does not propose the “automated verification and control of components (such as valves)”, nor does it propose to define the logic required by these components. The present invention proposes to establish a method for testing the sequencing logic of the BDVs, a logic that is well established but difficult to implement and verify.

Some advantages of the present invention can be highlighted related to economic and productivity advantages, since the present invention significantly reduces the time and resources required for verifying the sequencing logic implemented in the control systems. Without the invention, tests were performed manually, one by one, with continuous supervision by analysts.

The tabulated results needed to be compared manually, or in a non-standardized way, by using Excel or other means, to determine the differences between the expected behavior and the obtained behavior. In addition, the expected result itself needed to be calculated by the analysts for each test case. The increased reliability of the sequencing program results in a reduced risk of failures, minimizing equipment and production losses.

There are also health and safety advantages, since the increased reliability of the sequencing program also reduces the risk of failures that could result in fires and explosions, thus preventing injuries and deaths. There are advantages related to reliability, since the proposed method allows for a high number of tests to be carried out, as many as necessary, in a fraction of the time that would be required by the manual method.

With the increase in the number of test cases, the number of untested scenarios is reduced and, consequently, the confidence that the sequencing program will not fail when demanded is increased. And, finally, there are environmental advantages, because the increased reliability of the sequencing program results in a lower risk of failures that could fuel fires and explosions, which could cause spills and environmental damage.

### SUMMARY OF THE INVENTION

The present invention relates to a computer program-implemented method for automated verification of the sequencing logic of the opening of blowdown valves (BDVs). The method is implemented by a computer program that was developed specifically for this purpose, with the practical advantage of allowing a much larger number of test cases (or scenarios) compared to the approach prior to the invention. The method is based on a scenario-guided prioritization study, in which, given a set of scenarios to be tested, the decay curves of the BDVs and the prioritization rules, a computer program implemented method is used in a chained manner, comprising the main steps of: 1. standardization of the scenario definition; 2. calculation of the sequencing of the BDVs that respects the capacity limit of the flare and the prioritization rules for each scenario; 3. translation of this sequencing into a visual format that allows analysis by a specialist; 4. automated testing of each scenario; and 5. generation of a report with the result of the tests, indicating whether or not the implemented logic met the expected sequencing.

Furthermore, the present invention relates to a non-transient, computer-readable storage medium comprising instructions stored therein, wherein the instructions, when read by a computer, cause the computer to execute the steps of the method as defined above. With the method of the present invention, it is possible to perform a test on a much larger number of scenarios than would be possible manually, in much less time (hours instead of weeks), with greater precision and lower cost, increasing the confidence in the program that performs the sequencing of the BDVs.

### BRIEF DESCRIPTION OF THE FIGURES

FIG. 1 is a diagram of an architecture of a Computer Implemented Method for Automated Verification of the Sequencing Logic of the Opening of Blowdown Valves (BDVs) following a scenario-guided prioritization study, according to an embodiment of this application.

FIG. 2 is a graph representing the results of an algorithm that ensures that each BDV, when opening, does not exceed the Flare limit.

FIG. 3 exemplifies the “black box” test: the computer-implemented method executes the inputs that represent the test scenario and observes the outputs. Once the expected sequence is calculated, the method gives a verdict on the correctness of the implemented program when the observed behavior coincides or does not coincide with the expected behavior.

### DETAILED DESCRIPTION OF THE INVENTION

The present invention provides a Computer Implemented Method for Automated Verification of the Sequencing Logic of the Opening of Blowdown Valves (BDVs) following a scenario-guided prioritization study and a Computer-Readable Non-Transient Storage Medium. In general, the method comprises the steps of: 1) standardization of the scenario definition; 2) calculation of the sequencing of the blowdown valves, taking into account the capacity limit of the safety equipment (flare) and the prioritization rules for each scenario; 3) translation of the sequencing into a format that configures the execution of the scenarios and allows for visual representation; 4) automated testing of each scenario; and 5) generation of a report with the result of the tests, indicating whether the implemented logic met the expected sequencing.

To understand the scenarios and objectives of the method, assume that the industrial unit is subdivided into subprocesses built in separate modules and then assembled and interconnected on an FPSO-type production platform.

Each module is named M01, M02, etc., and contains a set of BDVs that relieve (depressurize) the Flare (safety equipment) in case of a confirmed fire in the module area. Consider that the operator can manually actuate, whenever desired, the BDVs of other adjacent modules or even a specific BDV to mitigate the consequences.

Given the disclosure above, it is also important to consider that a BDV, when it opens, relieves to the Flare a higher initial flow rate that decreases exponentially over time, insofar as the inventory is relieved. The decay of the flow rate of a BDV opens up space in the Flare for the opening of other BDVs without exceeding the maximum flow rate of the same.

Given this, an example of a possible scenario would be a confirmed fire in module M01 with the consequent action of the operator opening BDV-002, 30 sec after the fire confirmation. In this scenario, the BDVs of module M01 must open in the correct sequence, without exceeding the maximum flow rate of the Flare, in addition to accommodating the flow rate of BDV-002, that is, BDV-002 must open soon after 30 seconds, as soon as the decay of the flow rate of the already opened BDVs allows.

In this case, the opening sequence of the BDVs of module M01 is delayed until the flow rate of BDV-002 drops to the point of allowing other BDVs to open. With the opening of the BDVs, the gas inventory is sent to the Flare, and the unit is depressurized, preventing explosions and greater damage. Note that the number of possible scenarios is combinatorial, since it is not possible to predict which modules will have fire in the area, at what time, or when the operator will take manual actions.

There must be prioritization rules to determine a depressurization queue dynamically, at runtime. For example, there may be a rule that prioritizes the manually activated BDV over the others. This BDV then moves ahead of the others in the queue.

Other rules may, for example, determine that the priority for opening the BDVs, when fire is detected in module M01 and later in module M02, is different from that when the fire occurs in module M02 and later in module M01. When fire occurs in two modules simultaneously, there may be a rule that prioritizes the opening of the BDVs of one module over the other.

These prioritization rules impact the depressurization queue in real time. That is, the program that implements and executes the sequencing of the BDVs must react to the real conditions and change the depressurization queue according to the rules.

Whatever the scenario, the sequencing program (set of computer executable instructions) must calculate the depressurization queue, estimate at each instant the available capacity in the Flare, compare it with the initial flow rate of the BDV with the highest priority in the depressurization queue, and authorize the opening of this valve when there is available capacity in the Flare.

Due to the complexity and risks involved, it is imperative to test as many scenarios as possible, in order to ensure that the program implemented in the sequencing executor will behave as expected. The objective of the method of the present invention is precisely to allow a practical way to test a large number of scenarios to verify the correctness of the sequencing program implemented in the sequencing executor.

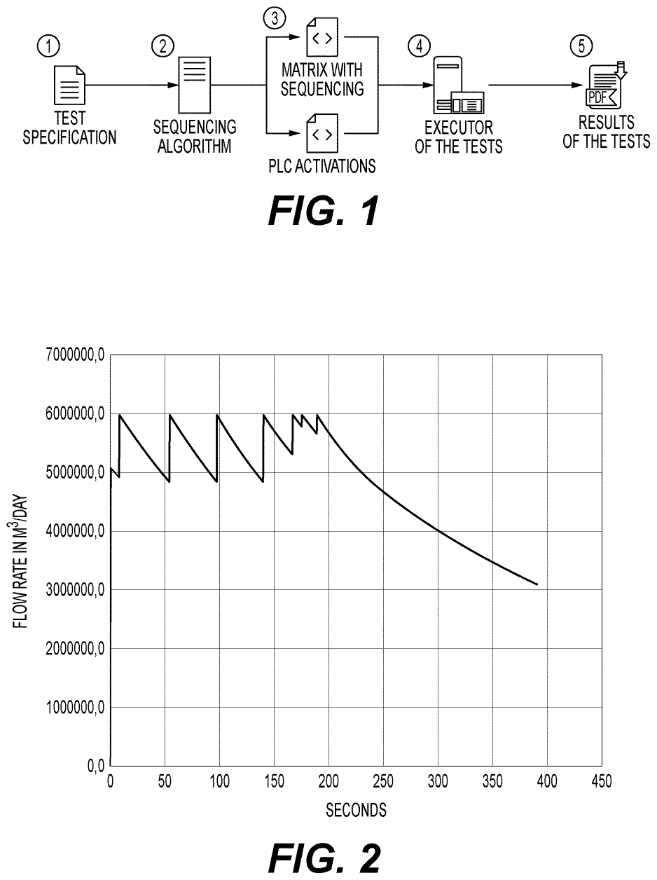

The method is represented in FIG. 1, with the steps numbered from 1 to 5.

### Description of Step 1—Test Specification

In step 1, the analyst standardizes the definition of the scenarios, describing the set of scenarios he/she wants to test in a file with the test specification. In this file, the analyst names the scenario and the sequence of activations (fire confirmed and manual operator activations) of that scenario. For example, in a “scenario 1”, the analyst wants to know if the sequencing logic of the BDVs will execute correctly if there is a fire in module M01 at time zero, followed by the operator's action of opening BDV-002 at time 30 seconds.

Another scenario, named “scenario 2”, could involve a fire in module M03 followed by a fire in adjacent modules M05 and M08 at times 0, 40, and 80 seconds respectively, in addition to the operator actuating the existing BDVs in module M02 at time 60 seconds.

Specifically, the test specification is performed using a JSON file, describing the test scenarios as follows:

```
{
  “scenarios”:
    [
      {
        “name”:”scenario 1”,
        “activations”:[
          {“which”:”M01”, “actuation”:”fire”, “delay”:0.0},
            {“which”:”BDV002”,”actuation”:”manual”,”delay”:30.}
        ]
      },
      {
        “name”:”scenario 2”,
        “activations”:[
          {“which”:”M03”, “actuation”:”fire”, “delay”:0.0},
            {“which”:”M05”, “actuation”:”fire”, “delay”:40.0},
            {“which”:”M08”, “actuation”:”fire”, “delay”:80.0},
            {“which”:”M02”, “actuation”:”manual”, “delay”:60.0}
        ]
      }
    ]
}
```

The analyst can add as many scenarios as necessary. Once the scenarios are specified, proceed to step 2 of the method.

### Description of Step 2—Sequencing Algorithm

The specification of the test scenarios is then translated in step 2 into a set of BDV sequencings, one sequencing for each scenario. The sequencing algorithm must receive the specification of the scenarios from the previous step, the priority tables of each BDV, and the rules that allow the calculation of the queue or sequencing of depressurization of the blowdown valves which, together with the flow rates and decay rates, allow the composition for each scenario of the opening sequence of the BDVs.

The algorithm must ensure that each BDV, when opened, does not exceed the maximum operating flow rate of the Flare. FIG. 2 illustrates this issue: the graph shows that the next BDV will only be opened (indicated in the graph by an instantaneous rise in the Flare flow rate) when the decay of the flow rate in the previous BDVs allows the BDV to open without exceeding the maximum flow rate of the Flare, which in the example shown in the figure is 600,000 m³/day.

Note that the method uses prioritization rules, but does not define the same. The prioritization rules are defined externally and imported into the test method. These same rules were used in the implementation of the sequencing program that one wishes to test.

To illustrate how the algorithm works, imagine that the BDVs of module M01 and those of module M02 have the priority defined in Table 1 below, and that there is sharing of BDVs between the modules. A rule could be that if there is a fire in module M01 and later in module M02, module M01 must finish its sequencing before the sequencing of the BDVs of module M02 begins.

Thus, the priority queue becomes that of Table 2, such that the priorities of module M01 are maintained and those of module M02 come next, that is, BDV-05 becomes the fourth valve and BDV-04 becomes the fifth valve in the sequencing, since BDV-01 was prioritized in module M01.

TABLE 1
Example of BDVs priorities in case of confirmed
fire in each module separately

| BDV | M01 | M02 |
|---|---|---|
| BDV-01 | 1 | 3 |
| BDV-02 | 3 | — |
| BDV-03 | 2 | — |
| BDV-04 | — | 2 |
| BDV-05 | — | 1 |

TABLE 2
Priorities queue and sequencing after
application of the example rule

| BDV | Queue | Sequence |
|---|---|---|
| BDV-01 | 1 | 0.0 s |
| BDV-02 | 2 | 10.0 s |
| BDV-03 | 3 | 45.0 s |
| BDV-04 | 4 | 53.0 s |
| BDV-05 | 5 | 77.0 s |

To complete Table 2, the sequencing algorithm needs to define the actuation times of each BDV in the sequence. This is done considering the following flow decay rule:

$$V\_bdv ( t ) = Vmax\_bdv * e \hat{} ( - ( t - t 0 ) * C\_bdv ) ,$$

t0 is the actuation time of the BDV;
t is the elapsed time, with t>t0;
V_bdv(t) is the flow rate of the BDV at time t; For t<t0, V_bdv(t) is zero;
Vmax_bdv is the maximum flow rate of the BDV and occurs at t=t0;
C_bdv is a decay constant of the respective BDV.

For implementation in digital systems, the formula can be simplified to:

$$V\_bdv ( t ) = V\_bdv ( t - dt ) * R\_bdv ,$$

R_bdv=e\hat{ }(−dt*C_bdv) is a constant decay rate;
dt=a period between flow samplings.

Thus, by applying the formula, the flow rate in a BDV behaves as follows:

$$t 0 = t 0 -> V\_bdv ( t 0 ) = Vmax\_bdv ;$$

$$t 1 = t 0 + dt -> V\_bdv ( t 1 ) = V\_bdv ( t 0 ) * R\_bdv ;$$

$$t 2 = t 1 + dt -> V\_bdv ( t 2 ) = V\_bdv ( t 1 ) * R\_bdv ;$$

$$t 3 = t 2 + dt -> V\_bdv ( t 3 ) = V\_bdv ( t 2 ) * R\_bdv ;$$

$$…$$

$$and so on .$$

With this formula and the characteristics of the BDVs (Vmax_bdv and R_bdv), the sequencing algorithm is able to predict the future flow rates of all BDVs and compare them with the Flare limit, in order to define the time when the next BDV in the sequence could be actuated without exceeding this limit.

In addition, based on the formula and the specific characteristics of the BDVs (Vmax_bdv and R_bdv), the priority relations established between the same, and the fire detection times in the modules, the algorithm performs a temporal simulation, calculating, for each time interval tk (k=[0, 1, 2, . . . ]), the occupied flow rate of the Flare system. This calculation considers the already opened BDVs and their respective flow rate decay curves, verifying if the Flare's idle capacity is sufficient to accommodate the next BDV with priority for opening.

The BDV with the highest priority should be opened as soon as the algorithm determines that its activation will not exceed the Flare's capacity limit. For each opening performed, the algorithm records in memory the BDV identification and the exact instant it was activated. The algorithm's termination criterion occurs when all programmed BDVs have been effectively opened. At the end, the algorithm provides a sequential set of actuations, specifying each opened BDV and the respective opening time.

As an example, for the calculation of the times in Table 2, the algorithm calculates that, 10 seconds after the opening of BDV-01, the flow rate will have decayed enough to allow the opening of BDV-03. Similarly, the algorithm calculates that the sum of the flow rates of BDV-01 and BDV-03 will have decayed enough for the opening of BDV-02 at time t=45 seconds, and so on for the other BDVs in the sequence.

Thus, the prioritization rules determine the depressurization queue which, given the flow rates and decay of each BDV, results in the sequence of opening of the BDVs (Table 2).

### Description of Step 3—Test Configuration and Visualization

TABLE 3
Sensors to Indicate Fire Detected in the Modules

| Module | Sensors |
|---|---|
| M01 | 2oo3 Vote between FGS-001A, FGS-001B and FGS-001C |
| M02 | 2oo3 Vote between FGS-002A, FGS-002B and FGS-002C |
| M03 | 2oo3 Vote between FGS-003A, FGS-003B and FGS-003C |

Step 3 introduces into the method the configuration and visualization of the sequencing calculated in the previous step, translating the sequencing into a format that configures the execution of the scenarios and allows a visual representation. The scenarios are grouped into two files: the first, “Sequencing Activations”, which details the sensors that trigger the scenarios under test, while the second, “Matrix with sequencing”, details the valves actuated in each scenario, in the correct order and at the correct actuation times.

These files, automatically generated from the previous phase of the method, also incorporate the mapping of the reading and writing points of the equipment under test, which implements the sequencing logic, so as to allow the method to execute commands on the equipment under test and obtain the responses from that equipment.

As an example, suppose that fire detection in module M01 is done through a 2003 (2 out of 3) vote of the fire sensors FGS-001A, FGS-001B, and FGS-001C (see Table 3), meaning that fire must be detected by at least two of these three sensors to activate the sequencing of module M01. The information from sensors, votes, addresses, and other necessary information for the actuation are provided to the method and translated in the file that configures the sensors.

In this way, the method is able to generate signals that actuate these sensors in various combinations. If the scenario under test involves fire detection in module M01, the configuration file informs the method that it is necessary to actuate combinations of at least two of these sensors and that a single sensor should not be able to actuate the scenario.

The second file formalizes the sequencing result, informing the method, in addition to the sequencing calculated in the previous phase, also the configuration so that the actuation of the valves in the equipment under test can be detected. This file essentially consists of a Cause and Effect Matrix, where the causes are the signals from the ‘Sequencing Activations’ Matrix, which indicate the detection of fire in the module, and the effects, which correspond to the opening of the valves associated with each module, linked to a time constraint that defines the expected time for the valve to be actuated by the executor of the sequencing logic.

These files can be used by the method to generate visualizations of the tests, allowing the analyst to visualize the sensors that will be actuated and the expected sequence of BDV actuation for each test scenario.

### Description of Step 4—Execution of the Tests

Step 4 is the execution of the tests or automated testing of each scenario. The computer program implemented method, described in Veiga, H. W., de Queiroz, M. H., Farines, J. M., de Lima, M. L. (2017). Automatic Conformance Testing of Safety Instrumented Systems for Offshore Oil Platforms. In: Petrucci, L., Seceleanu, C., Cavalcanti, A. (eds) Critical Systems: Formal Methods and Automated Verification. AVoCS FMICS 2017 2017. Lecture Notes in Computer Science ( ), vol 10471. Springer, Cham. https://doi.org/10.1007/978-3-319-67113-0_4, generates the test signals and applies these tests to the sequencing executor loaded with the logic to be tested, which implements the sequencing rules.

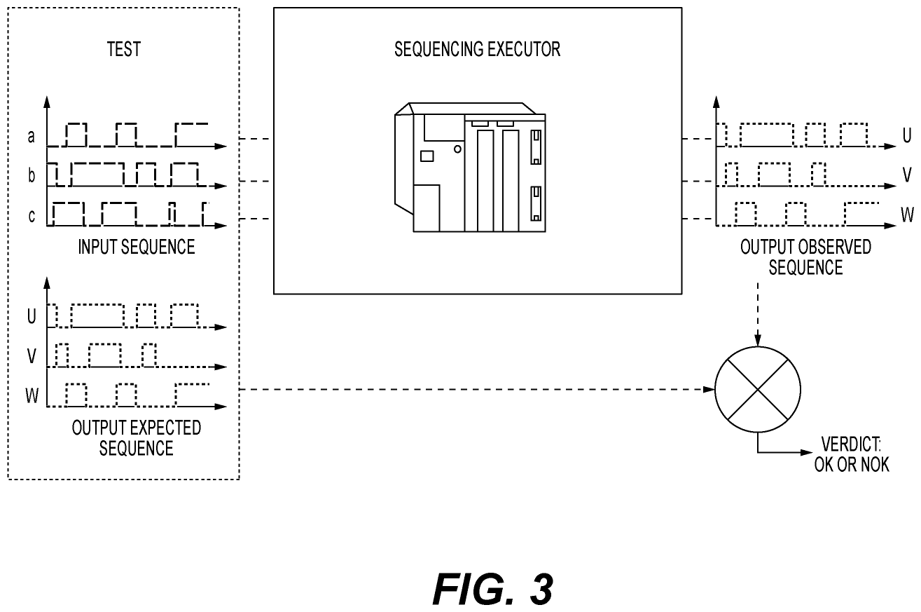

The test execution is performed in a “black box,” meaning that it is not necessary to know the logic implemented in the sequencing executor, but only the expected behavior. FIG. 3 exemplifies the “black box” test: The computer program implemented method forces the input sensors, in order to activate the expected test scenario, and records the outputs and their times, to verify the correctness of the implemented program by comparing whether the observed behavior coincides with the expected behavior.

The computer program implemented method allows interaction with the sequencing executor through standardized communication interfaces such as OPC-UA, for example. For each scenario, the test program will generate combinations of signals that activate the scenario and will observe the executor's output to determine if the logic actuates the BDVs in the correct sequence and at the expected intervals.

The method enables the automatic execution of a series of test scenarios without human intervention, increasing the efficiency of the process.

After the tests are completed, the test software compiles the results into a report that differentiates between correct and incorrect scenarios, specifically identifying the valves that were actuated outside the programmed time. This report facilitates the rapid identification of faults, allowing for precise adjustments to the system.

### Description of Step 5—Test Results

In Step 5, the method generates a report with the result of the tests, indicating whether the implemented logic met the expected sequencing. The report contains the applied signals and the results of each test, allowing the analyst to know all the tests performed, their results, and reproduce the same if desired.

For each test, the report indicates the verdicts: OK, when the valves were actuated at the expected intervals; NOK when at least one valve did not open or did not respect the sequence at the correct time.

What is claimed is:

1. A computer implemented method for automated verification of sequencing logic of opening of blowdown valves, the method comprising the steps of:
1) standardization of a scenario definition;
2) calculation of a sequencing of the blowdown valves, taking into account a capacity limit of safety equipment and prioritization rules for each scenario;
3) translation of the sequencing into a format that configures execution of the scenarios and allows for visual representation;
4) automated testing of each scenario; and
5) generation of a report with a result of the testing, indicating whether implemented logic met an expected sequencing.

2. The method according to claim 1, wherein the automated verification is a consequence of a flow rate limit of the safety equipment, a flow rate characteristic of the blowdown valves, priorities, and rules for changing the priorities.

3. The method according to claim 1, wherein the method further comprises a test of the sequencing logic of the blowdown valves, ensuring that the logic behaves as expected.

4. The method according to claim 1, further comprising:
calculating a depressurization queue or sequencing,
estimating an available capacity in the safety equipment,
comparing the available capacity in the safety equipment with an initial flow rate of the blowdown valve with highest priority in the depressurization queue, and
authorizing opening of blowdown valve with highest priority in the depressurization queue when there is available capacity in the safety equipment.

5. The method according to claim 1, wherein, in step 1, an analyst describes a set of scenarios to be tested in a file with a test specification, and
wherein the scenarios and the sequence of activations of the scenarios are named in the file.

6. The method according to claim 5, wherein the test specification describes the test scenarios, and wherein the analyst optionally adds a plurality of scenarios.

7. The method according to claim 5, wherein, in step 2, the test specification is translated into a set of blowdown valve sequencings, with one sequencing for each scenario of the set of scenarios.

8. The method according to claim 5, wherein, in step 2, a set of sequencing instructions receives the test specification of the set of scenarios from step 1, a priority table for each blowdown valve, and rules that allow calculation of a depressurization queue, which together with flow rates and decay rates allow a set of instructions to be composed for each scenario for an opening sequence of the blowdown valves.

9. The method according to claim 1, wherein the method uses externally defined prioritization rules, and wherein the prioritization rules determine a depressurization queue from flow rates and decay rates of each blowdown valve.

10. The method according to claim 1, wherein, in step 3, the scenarios are translated into two files allowing configuration of the tests and visualization of the scenarios, and
wherein a first file details the actuations and their configurations, and the second file refers to the sequencing of the opening of the blowdown valves.

11. The method according to claim 1, wherein step 4 comprises generation of test signals and application of the tests signals in a sequencing executor loaded with the logic to be tested, and which implements sequencing rules.

12. The method according to claim 11, wherein, in step 4, the execution of the tests is done without knowing the logic implemented in the sequencing executor, but only the expected behavior.

13. The method according to claim 11, wherein the set of test instructions interacts with the sequencing executor through standardized communication interfaces, preferably OPC-UA.

14. The method according to claim 11, wherein, after completion of automated testing in step 4, results are compiled into a report by the set of instructions,
wherein the report differentiates between correct and incorrect scenarios, specifically identifying the valves that were actuated outside a programmed time.

15. The method according to claim 14, wherein the report contains the applied signals and the results of each test.

16. The method according to claim 1, wherein the report indicates:
OK, when the blowdown valves are actuated at the expected intervals; and
NOK, when at least one blowdown valve does not open or does not respect the sequence at the correct time.

17. A computer-readable non-transient storage medium comprising a set of stored instructions that, when read by a computer, cause the computer to execute the steps of the method according to claim 1.
